(19) United States
(12) Patent Application Publication
(10) Pub. No.: US 2019/0065716 A1
(43) Pub. Date: Feb. 28, 2019

(54) ATTACK RESISTANT BIOMETRIC AUTHORISED DEVICE

(71) Applicant: ZWIPE AS, Oslo (NO)

(72) Inventor: Jose Ignacio Wintergerst LAVIN, Colorado Springs, CO (US)

(21) Appl. No.: 16/077,598

(22) PCT Filed: Mar. 1, 2017
(86) PCT No.: PCT/EP2017/054792

§ 371 Date: Aug. 13, 2018

Related U.S. Application Data
(60) Provisional application No. 62/302,836, filed on Mar. 3, 2016.

(30) Foreign Application Priority Data
Mar. 24, 2016 (GB) 1605047.8

(51) Int. Cl. G06F 21/32; G06Q 20/40

(52) U.S. Cl. CPC G06F 21/32; G06Q 20/40

(57) ABSTRACT

A biometric authorised device may include a biometric sensor, a processing unit for receiving an output signal from the biometric sensor, and one or more protected feature(s). Access to the protected feature(s) of the device is enabled in response to identification of an authorised user via biometric data supplied through the biometric sensor to the processing unit and the device is arranged to compare the output signal of the biometric sensor with stored data based on earlier output signals for authorised users. If the output signal is found to be identical to one of the earlier output signals then access to the protected feature(s) is not permitted.

The present invention relates to a biometric authorised device with improved resistance to fraudulent use and to a method for controlling such a biometric authorised device.

Biometric authorised devices such as fingerprint authorised smartcards are becoming increasingly more widely used. Smartcards for which biometric authorisation has been proposed include, for example, access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with sensors to communicate information in order to enable access, to authorise transactions and so on. Other devices are also known that make use of biometric authorisation such as fingerprint authorisation, and these include computer memory devices, building access control devices, military technologies, vehicles and so on.

Other devices can also be enhanced with biometric authorisation, which has for example also been proposed for control tokens such as fobs for vehicle keyless entry systems. In vehicles a remote keyless entry system performs the functions of a standard car key without physical contact. The system may also perform other functions, for example opening the trunk or starting the engine. Similar control tokens can be used for other access control situations, as well as for other purposes requiring interaction with an external system using wireless transmission, for example to actuate an electrical device. It has been proposed to include biometric authorisation on such devices, for example fingerprint authorisation. In this case some or all functions of the control token would only be available after the identity of the user had been authorised via a biometric sensor.

Even with the use of a biometric sensor attacks on the security of the device are still possible. Such attacks include physical attacks on the integrity of the device as well as computer based “hacking” of the device and/or the external systems that interact with the device. Some protection can be provided by the use of encrypted communications between the device and external systems. Encrypted data transfer between internal processors or controllers of the device has also been proposed. Nonetheless there remains an on-going need to improve the resistance of biometric authorised devices to attacks on their security

Viewed from a first aspect the invention provides a biometric authorised device comprising a biometric sensor, a processing unit for receiving an output signal from the biometric sensor, and one or more protected feature(s); wherein access to the protected feature(s) of the device is enabled in response to identification of an authorised user via biometric data supplied through the biometric sensor to the processing unit; wherein the device is arranged to compare the output signal of the biometric sensor with stored data based on earlier output signals for authorised users; and wherein if the output signal is found to be identical to one of the earlier output signals then access to the protected feature(s) is not permitted.

This device is protected against the use of a false signal inserted into the authorisation path. A common way to attempt to access a secure device without authorisation is to attack the system by recording a valid signal during earlier use of the device and inserting a false signal into the authentication path, with the false signal copying the earlier signal. This type of attack is sometimes referred to as a “sniffer” attack. Such a false signal will be identical to the earlier signal and could otherwise enable access to the protected features. The proposed use of a comparison of the output signal from the sensor with earlier output signals, with identical signals being rejected, is based on the realisation that real-world output signals from biometric sensors will never be identical for multiple instances of idenifying the same user. There is always some variation in how the user presents themselves to the device for biometric authorisation as well as some noise and so on arising from normal operation of the biometric sensor. Thus, counterintuitively, it is necessary to reject biometric data that is identical to earlier biometric readings.

It is of course possible to protect a biometric authorised device by using encrypted data as noted above. However, the biometric sensor itself is generally not logically capable of encryption and consequently the data signal from the sensor cannot be encrypted until it reaches the processor. This therefore gives rise to a potential weakness when the unencrypted signal from the sensor is passed to the processing unit. The biometric authorised device would of course normally be constructed to restrict access to the physical connections that convey this unencrypted signal, and preferably the processing unit would be in close proximity to the biometric sensor with the electrical connections not readily accessible, for example they may be encapsulated in plastic or the like, but nonetheless it remains feasible that a skilled attack on the device might be able to access the signal paths for the unencrypted data and thereby allow for recording of the output signal and fraudulent use of the device with a recorded signal. The proposed comparison and checking for identical signals protects against this possibility.

In an example embodiment the device includes a signal checking module for providing a signal checking parameter derived from the output signal sent from the biometric sensor to the processing unit, the signal checking parameter being determined as a function of the output signal with the same function being used each time the processing unit receives an output signal from the biometric sensor and a number of past signal checking parameters being stored on the device; and wherein the device is arranged such that in the event of a new output signal being presented to the processing unit a new signal checking parameter is determined, the new signal checking parameter is compared to the stored signal checking parameters, and if the new signal checking parameter is identical to one of the stored signal checking parameters then access to the protected features of the secure element is not permitted.

The signal checking parameter allows for an identical output signal to be easily seen by the device based on a comparison with a number of earlier signal checking parameters stored on the device.

This sentence makes it clear that a more laborious comparison may be used, before I then explain the possibility of a checksum type calculation as the preferred option.

The comparison of the output signal with past output signals may be carried out in a similar way to conventional biometric comparisons to check for an authorised user, with the main difference being that a match is not found for identical or very similar signals. Thus, where a signal checking module is used then the function used by the signal checking module may be similar to conventional biometric authorisation algorithms with the signal checking parameter hence equivalent to a confidence score for biometric authorisation and being compared to multiple earlier stored readings. In this case the device may reject biometric authorisation attempts with output data that is identical or too similar to one of the earlier recorded parameters, i.e. too close to an earlier recorded biometric data signal, whilst at the same time accepting biometric authorisation attempts that are within a set threshold that defines a match without being too similar. However this process is cumbersome and potentially slow since it could involve essentially performing a biometric authorisation based on multiple stored earlier biometric templates, and it may result in false negatives. It also requires a relatively large amount of storage for the past signal checking parameters.

In another example, as used in preferred embodiments, the comparison of the output signal with past output signals is done based on a simplified representation of the output signal and the past output signals. Where a signal checking module is used then the function used by the signal checking module provides a numeric value as the signal checking parameter. This allows for storage of many past signal checking parameters without the need for a large memory capacity. It also means that the comparison of the new output and old output signals is very quick. The simplified representation of the signals may be based on a checksum calculation and hence the signal checking module may be a checksum calculation module, with the signal checking parameter being the checksum. A checksum provides a quick and effective check to indicate when an output signal purportedly from the biometric sensor is identical to an earlier output signal and hence is most likely a false signal based on a recording of the earlier signal.

With the use of a checksum the signal going into the processing unit is subjected to a checksum calculation. This checksum is stored every time a biometric reading is taken. A limited number of checksums are temporarily stored at any one time and the store may be updated when a new good reading is found, i.e. when a user is identified as an authorised user. When new readings are taken then the new checksum is compared to previous checksums. If the new checksum is the same as previous ones then this is prima facie evidence that the new reading is false.

The protected features of the device may be any features requiring the security of a biometric authorisation. This may include one or more of: enabling communication of the device with an external system, for example contactless communication; sending certain types of data to an external system; allowing access to a secure element of the device, such as a secure element used for financial transactions, permitting a transaction between the device and an external system; enabling access to data stored on the device and so on.

The processing unit may be connected to or may be a part of a control system of the device. If there is a separate control system then it is preferred for the processing unit to communicate with the control system using encrypted data.

A secure element may be included in the device as a part of the control system and/or may be connected to the control system, preferably with encrypted communication between the secure element and the control system. The secure element may be a secure element for financial transactions as used, for example, on bank cards.

The control system may be arranged to execute a biometric matching algorithm and may include a memory for storing enrolled biometric data. The control system of the device may include multiple processors. This may include the processing unit that receives the signal from the biometric sensor. Other processors may include a control processor for controlling basic functions of the device, such as communication with other devices (e.g. via contactless technologies), activation and control of receivers/transmitters, activation and control of the secure element. The various processors could be embodied in separate hardware elements, or could be combined into a single hardware element, possibly with separate software modules.

The biometric sensor could use any suitable biometric to check the identity of the user. In example embodiments fingerprint authorisation is used. This can be implemented with low power usage and without increasing the size of the control token compared to existing similar control tokens, such as vehicle key fobs.

The biometric sensor may hence be a fingerprint sensor. In a preferred embodiment the control system and/or the processing unit may be capable of performing both an enrolment process and a matching process on a fingerprint of a finger presented to the fingerprint sensor.

The device may be a portable device, by which is meant a device designed for being carried by a person, preferably a device small and light enough to be carried conveniently. The device can be arranged to be carried within a pocket, handbag or purse, for example. The device may be a smartcard such as a fingerprint authorisable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like. The device may nonetheless have multiple operating modes, each of which involves interacting with the same type of external system or network, for example the ability to operate as a card for two different bank accounts, or the ability to interact with NFC devices as an access card or as a payment card.

Where the device is a smartcard then smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to biometric identification of an authorised user. Alternatively the control token may act as a remote locking type key, with the signal for unlocking the vehicle only being able to be sent if the device identifies an authorised user. In this case the identification of the authorised user may have the same effect as pressing the unlock button on prior art keyless entry type devices, and the signal for unlocking the vehicle may be sent automatically upon identification of an authorised user, or sent in response to a button press when the control token has been activated by authentication of an authorised user.

It is preferred for the device to be arranged so that it is impossible to extract the data used for identifying users via the biometric authorisation. The transmission of this type of data outside of the device is considered to be one of the biggest risks to the security of the device.

To avoid any need for communication of the biometric data outside of the device then the device may be able to self-enrol, i.e. the device may be arranged to enrol an authorised user by obtaining biometric data via the biometric sensor. This also has advantages arising from the fact that the same sensor with the same geometry is used for the enrolment as for the biometric authorisation. The biometric data can be obtained more consistently in this way compared to the case where a different sensor on a different device is used for enrolment. With biometrics and in particular with fingerprints, one problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced.

In accordance with the proposed device, both the matching and enrolment scans may be performed using the same biometric sensor. As a result, scanning errors can be balanced out because, for example, if a user tends to present their finger to a fingerprint sensor with a lateral bias during enrolment, then they are likely to do so also during matching.

The control system may have an enrolment mode in which a user may enrol their biometric data via the biometric sensor, with the biometric data generated during enrolment being stored on a memory. The control system may be in the enrolment mode when the device is first provided to the user, so that the user can immediately enrol their biometric data. The first enrolled user may be provided with the ability to later prompt an enrolment mode for subsequent users to be added, for example via input on an input device of the device after identification has been confirmed. Alternatively or additionally it may be possible to prompt the enrolment mode of the control system via outside means, such as via interaction between the device and a secure external system, which may be a secure external system controlled by the manufacturer or by another authorised entity.

Viewed from a second aspect, the present invention provides a method for protecting a biometric authorised device having a biometric sensor, a processing unit for receiving an output signal from the biometric sensor and a secure element with one or more protected feature(s), wherein access to the protected feature(s) of the secure element of the device is enabled in response to identification of an authorised user via biometric data supplied through the biometric sensor to the processing unit, the method comprising: storing data based on output signals received from users identified as authorised users; when a new output signal is received, comparing the new output signal of the biometric sensor with the stored data; and not enabling access to the protected feature(s) of the secure element if the output signal is found to be identical to one of the earlier output signals.

The method may be performed on a device as described in the first aspect and optionally with any of the other features discussed above. The method may also include not permitting access to the protected feature(s) if the new output signal is too similar to one of the stored output signals.

In an example embodiment the device includes a signal checking module for providing a signal checking parameter derived from the output signal sent from the biometric sensor to the processing unit and the method includes determining the signal checking parameter being as a function of the output signal with the same function being used each time the processing unit receives an output signal from the biometric sensor, storing a number of past signal checking parameters for authorised users, and, in the event of a new output signal being presented to the processing unit, determining a new signal checking parameter, comparing the new signal checking parameter to the stored signal checking parameters, and not enabling access to the protected features of the secure element if the new signal checking parameter is identical to one of the stored signal checking parameters.

The comparison of signals and/or the implementation of the signal checking module may be as described above, and thus the method may include using a checksum.

Viewed from a third aspect, the present invention provides a computer programme product for a biometric authorised device comprising a biometric sensor and a processing unit that receives an output signal from the biometric sensor, wherein access to the protected feature(s) of the secure element of the device is enabled in response to identification of an authorised user via biometric data supplied through the biometric sensor to the processing unit, the computer programme product comprising instructions that when executed on the processing unit will configure the processing unit to store data based on output signals received from users identified as authorised users; when a new output signal is received, compare the new output signal of the biometric sensor with the stored data; and to not enable access to the protected feature(s) of the secure element if the output signal is found to be identical to one of the earlier output signals.

The computer programme product may be for execution on a device as described in the first aspect and optionally a device with any of the other features discussed above. The computer programme product may configure the processing unit to perform the method of the second aspect and optionally any of the other method steps discussed above.

Certain preferred embodiments of the present invention will now be described in greater detail, by way of example only and with reference to the accompanying Figures, in which:

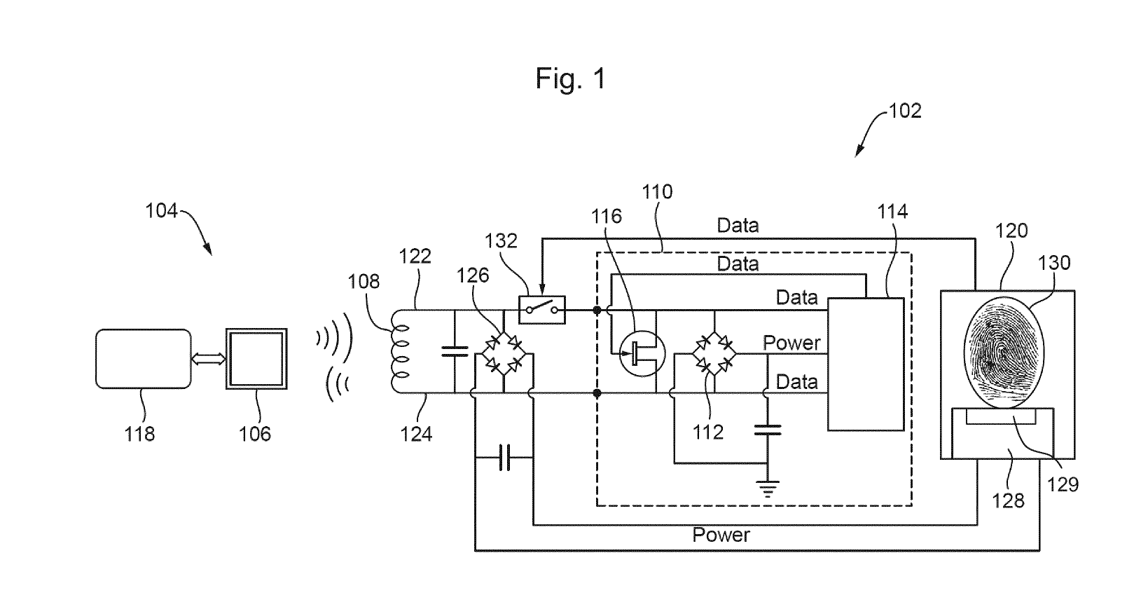

FIG. 1 illustrates a circuit for a passive RFID device incorporating biometric authorisation via a fingerprint scanner;

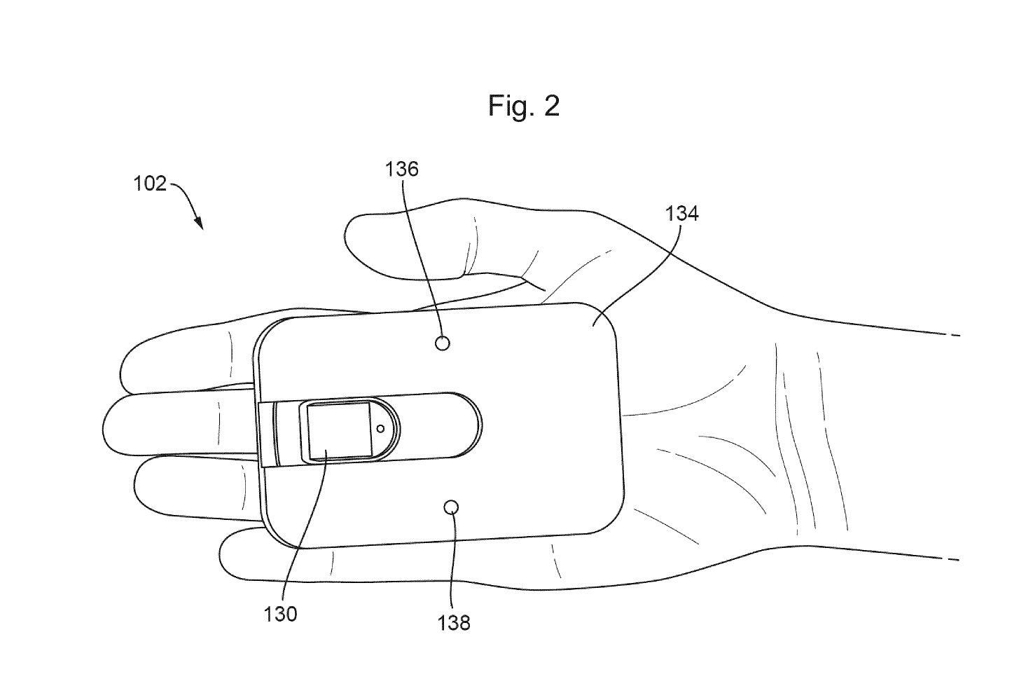

FIG. 2 illustrates a first embodiment of the passive RFID device having an external housing incorporating the fingerprint scanner;

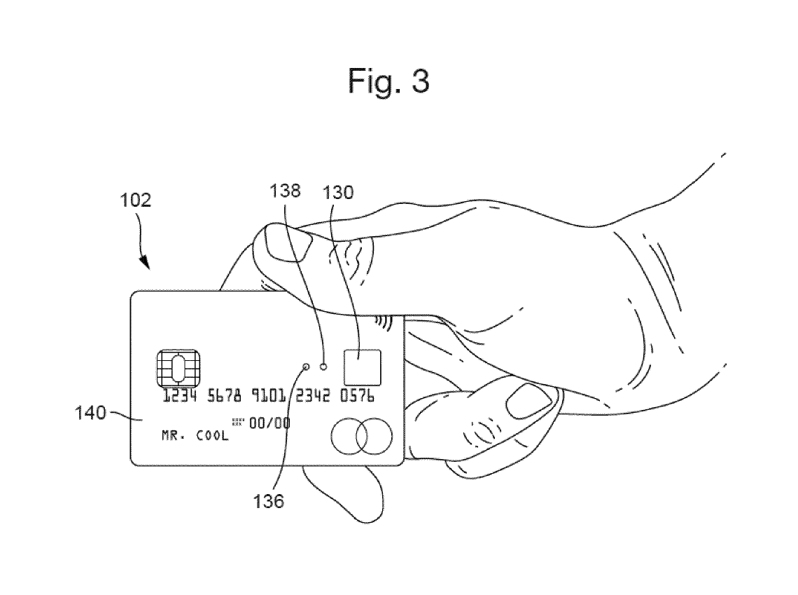

FIG. 3 illustrates a second embodiment of the passive RFID device where the fingerprint scanner is exposed from a laminated card body; and

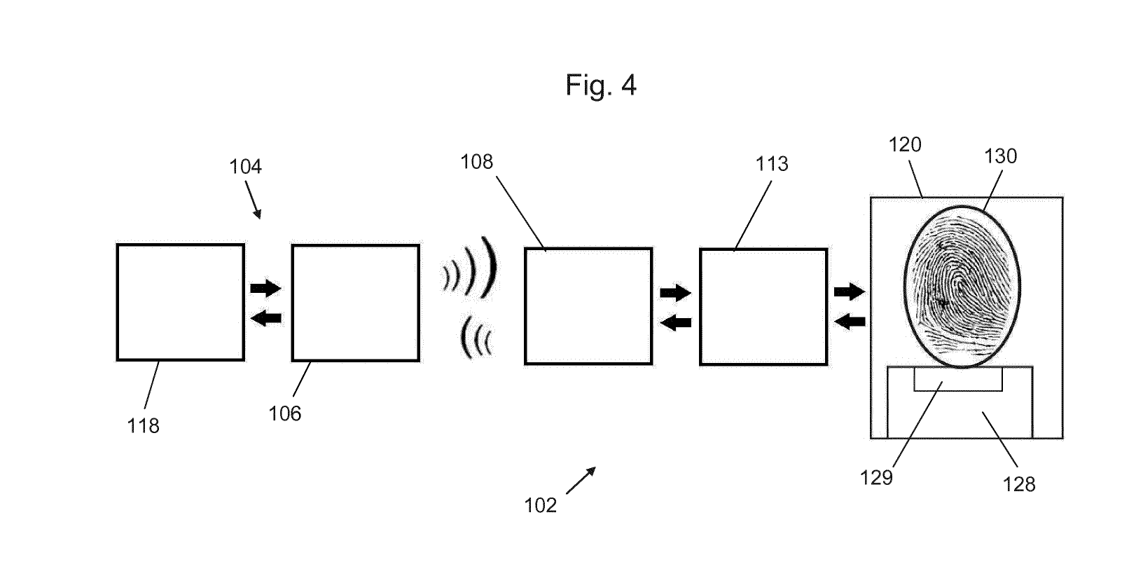

FIG. 4 is a schematic diagram of a fingerprint authorised wireless control token.

The preferred embodiments concern the use of a biometric authorised device 102 where the biometric authorisation system 120 is protected from “sniffer” type attacks by means of a signal checking module in the form of a checksum calculation module 129. The checksum calculation module 129 receives an output signal from a biometric sensor 130 of the biometric authorisation system 120 and this is used to generate a checksum. A number of checksums are stored and then the checksums from future output signals are compared with the stored checksums. In this way the checksum is used to find similar or identical signals indicative of a fraudulent use of a duplicate electrical signal between the biometric sensor and a processing unit 128 of the device. In FIGS. 1, 2 and 3 the biometric authorised device 102 is a smartcard and in FIG. 4 it is a wireless control token.

In these examples a fingerprint sensor 130 is used to provide a biometric authorisation before full access to the features of the smartcard 102 or control token 102 is permitted. This fingerprint sensor 130 is provided as a part of a fingerprint authorisation module 120 that also includes a dedicated processing unit 128. The processing unit 128 interacts with other processors/controllers of the biometric authorised device 102 in order to indicate when the user's identify has been confirmed biometrically. For example, the processing unit 128 interacts with the control circuit 114 of FIG. 1 or the control module 113 of FIG. 4 and this communication is can be encrypted. The communication between the sensor 130 and the processing unit 128 cannot be encrypted since the sensor 130 does not have the ability to modify its output signal to the processing unit 128.

There hence arises a risk of an attack on the device by recording and then duplicating the signals passing between the sensor 130 and the processing unit 128. In this way a “sniffer” attack might be able to record the signals produced when the identity of an authorised user is confirmed, and then reproduce those signals with the intention of fraudulently gaining access to the biometrically protected features of the device 102. In order to enable the biometric authorised device 102 to withstand such an attack the processing unit 128 includes the checksum calculation module 129.

The digital signal passed from the sensor 130 to the processing unit 128 is subjected to a checksum calculation performed by the checksum calculation module 129. This checksum is stored every time a biometric reading is taken from the authorised user(s). A certain number of checksums are temporarily stored at any one time, for example in a memory at the processing unit 128. An initial set of checksums can be obtained during enrolment of the user, or may be gathered during initial use of the device 102. When new biometric readings are taken then the checksum is compared to previous ones. If the checksum for a new biometric reading is the same or very similar to the previous ones then this is prima facie evidence that the new biometric reading is false. This is because biometric data such as fingerprints are by nature highly variable and “noisy” and therefore will almost never produce a reading which differs by only a few bits. The checksum calculation will show this more vividly and the result should be totally different between different readings for the same person. That is to say, two fingerprint authorisations by the same user with the same finger should produce a markedly different output from the checksum calculation, even when they would produce a fingerprint match with a high degree of confidence.

The only way that a pair of readings will be the same within a reasonable probability of doubt is if the latter reading was generated by a non-physiological source (perhaps a digital device such as a computer) and not as the result of a reading from a real finger.

In this way if two readings produce the same checksums then it is very likely that the system has been compromised and the appropriate measures should be taken. In particular, the processing unit 128 should not indicate that there is an authorised user and instead may initiate a security procedure, which may include sending an alert via a card reader or external system 104, and/or disabling the biometric authorised device 102.

FIG. 1 shows the architecture of a passive RFID biometric authorised device 102 incorporating the checksum calculation module 129. A powered RFID reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the RFID device 1022, comprising a tuned coil and capacitor, and then passed to an RFID chip 110. The received signal is rectified by a bridge rectifier 112, and the DC output of the rectifier 112 is provided to a control circuit 114 that controls the messaging from the chip 110.

Data output from the control circuit 114 is connected to a field effect transistor 116 that is connected across the antenna 108. By switching on and off the transistor 16, a signal can be transmitted by the RFID device 102 and decoded by suitable control circuits 118 in the reader 104. This type of signalling is known as backscatter modulation and is characterised by the fact that the reader 104 is used to power the return message to itself.

As used herein, the term “passive RFID device” should be understood to mean an RFID device 102 in which the RFID chip 110 is powered only by energy harvested from an RF excitation field, for example generated by the RFID reader 118. That is to say, a passive RFID device 102 relies on the RFID reader 118 to supply its power for broadcasting. A passive RFID device 102 would not normally include a battery, although a battery may be included to power auxiliary components of the circuit (but not to broadcast); such devices are often referred to as “semi-passive RFID devices”.

Similarly, the term “passive fingerprint/biometric authentication engine” should be understood to mean a fingerprint/biometric authentication engine that is powered only by energy harvested from an RE excitation field, for example an RF excitation field generated by the RFID reader 118.

The antenna 108 comprises a tuned circuit, in this arrangement including an induction coil and a capacitor, which are tuned to receive an RF signal from the RFID reader 104. When exposed to the excitation field generated by the RFID reader 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and supplied to the fingerprint authentication engine 120.

The fingerprint authentication engine 120 includes a processing unit 128, a checksum calculation module 129, and a fingerprint sensor 130, which is preferably an area fingerprint sensor 130 as shown in FIGS. 2 and 3. The fingerprint authentication engine 120 is passive, and hence is powered only by the voltage output from the antenna 108. The processing unit 128 comprises a microprocessor that is chosen to be of very low power and very high speed, so as to be able to perform biometric matching in a reasonable time.

The fingerprint authentication engine 120 is arranged to scan a finger or thumb presented to the fingerprint sensor 130 and to compare the scanned fingerprint of the finger or thumb to pre-stored fingerprint data using the processing unit 128. The checksum calculation module 129 produces a checksum each time the fingerprint sensor 130 sends a signal to the processing unit 128. The processing unit 128 stores a number of checksums for past output signals obtained when the fingerprint sensor identifies an authorised user. This may involve storing 5, 10 or 20 or more checksums, for example. When a new output signal is received the checksum calculation module 129 calculates a new checksum and the processing unit 128 compares this checksum to all of the stored checksums. If the new checksum is identical to a stored checksum then this indicates a false signal and access to protected features of the smartcard 102 is not enabled. If the new checksum is different to the stored checksums then access may be permitted if the fingerprint is a match to an enrolled fingerprint. Hence, if the checksum does not indicate a problem then a determination is then made as to whether the scanned fingerprint matches the pre-stored fingerprint data. In a preferred embodiment, the time required for capturing a fingerprint image and accurately recognising an enrolled finger is less than one second.

If a match is determined, then the RFID chip 110 is authorised to transmit a signal to the RFID reader 104. In the FIG. 1 arrangement, this is achieved by closing a switch 132 to connect the RFID chip 110 to the antenna 108. The RFID chip 110 is conventional and operates in the same manner as the RFID chip 10 shown in FIG. 1 to broadcast a signal via the antenna 108 using backscatter modulation by switching a transistor 116 on and off.

FIG. 2 shows an exemplary housing 134 of the RFID device 102. The circuit shown in FIG. 1 is housed within the housing 134 such that a scanning area of the fingerprint sensor 130 is exposed from the housing 134. FIG. 3 shows an alternative implementation in which the circuit shown in FIG. 1 is laminated within a card body 140 such that a scanning area of the fingerprint sensor 130 is exposed from the laminated body 140.

Prior to use the user of the RFID device 102 must first enrol his fingerprint date onto a “virgin” device, i.e. not including any pre-stored biometric data. This may be done by presenting his finger to the fingerprint sensor 130 one or more times, preferably at least three times and usually five to seven times. An exemplary method of enrolment for a fingerprint using a low-power swipe-type sensor is disclosed in WO 2014/068090 A1, which those skilled in the art will be able to adapt to the area fingerprint sensor 130 described herein.

The housing 134 or card body 140 may include indicators for communication with the user of the RFID device, such as the LEDs 136, 138 shown in FIGS. 2 and 3. During enrolment, the user may be guided by the indicators 136, 138, which tell the user if the fingerprint has been enrolled correctly. The LEDs 136, 138 on the RFID device 102 may communicate with the user by transmitting a sequence of flashes consistent with instructions that the user he has received with the RFID device 102.

After several presentations, the fingerprint will have been enrolled and the device 102 may be forever responsive only to its original user.

With fingerprint biometrics, one common problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing 134 or card body 140 around each fingerprint sensor must be carefully designed to guide the finger in a consistent manner each time it is read. If a fingerprint is scanned with a number of different terminals, each one being slightly different, then errors can occur in the reading of the fingerprint. Conversely, if the same fingerprint sensor is used every time then the likelihood of such errors occurring is reduced.

As described above, the present device 102 includes a fingerprint authentication engine 120 having an onboard fingerprint sensor 130 as well as the capability of enrolling the user, and thus both the matching and enrolment scans may be performed using the same fingerprint sensor 130. As a result, scanning errors can be balanced out because, if a user tends to present their finger with a lateral bias during enrolment, then they are likely to do so also during matching.

Thus, the use of the same fingerprint sensor 130 for all scans used with the RFID device 102 significantly reduces errors in the enrolment and matching, and hence produces more reproducible results.

In the present arrangement, the power for the RFID chip 110 and the fingerprint authentication engine 120 is harvested from the excitation field generated by the RFID reader 104. That is to say, the RFID device 102 is a passive RFID device, and thus has no battery, but instead uses power harvested from the reader 104 in a similar way to a basic RFID device 2.

The rectified output from second bridge rectifier 126 is used to power the fingerprint authentication engine 120. However, the power required for this is relatively high compared to the power demand for the components of a normal RFID device 2. For this reason, is has not previously been possible to incorporate a fingerprint sensor 130 into a passive RFID device 102. Special design considerations are used in the present arrangement to power the fingerprint sensor 130 using power harvested from the excitation field of the RFID reader 104.

One problem that arises when seeking to power the fingerprint authentication engine 120 is that typical RFID readers 104 pulse their excitation signal on and off so as to conserve energy, rather than steadily emitting the excitation signal. Often this pulsing results in a duty cycle of useful energy of less than 10% of the power emitted by steady emission. This is insufficient to power the fingerprint authentication engine 120.

RFID readers 104 may conform to ISO/IEC 14443, the international standard that defines proximity cards used for identification, and the transmission protocols for communicating with them. When communicating with such RFID devices 104, the RFID device 102 can take advantage of a certain feature of these protocols, which will be described below, to switch the excitation signal from the RFID reader 104 to continuous for long enough to perform the necessary calculations.

The ISO/IEC 14443-4 standard defines the transmission protocol for proximity cards. ISO/IEC 14443-4 dictates an initial exchange of information between a proximity integrated circuit card (PICC), i.e. the RFID device 102, and a proximity coupling device (PCD), i.e. the RFID reader 104, that is used, in part, to negotiate a frame wait time (FWT). The FWT defines the maximum time for PICC to start its response after the end of a PCD transmission frame. The PICC can be set at the factory to request an FWT ranging from 302 μs to 4.949 seconds.

ISO/IEC14443-4 dictates that, when the PCD sends a command to the PICC, such as a request for the PICC to provide an identification code, the PCD must maintain an RF field and wait for at least one FWT time period for a response from the PICC before it decides a response timeout has occurred. If the PICC needs more time than FWT to process the command received from the PCD, then the PICC can send a request for a wait time extension (S(WTX)) to the PCD, which results in the FWT timer being reset back to its full negotiated value. The PCD is then required to wait another full FWT time period before declaring a timeout condition.

If a further wait time extension (S(WTX)) is sent to the PCD before expiry of the reset FWT, then the FWT timer is again reset back to its full negotiated value and the PCD is required to wait another full FWT time period before declaring a timeout condition.

This method of sending requests for a wait time extension can be used to keep the RF field on for an indefinite period of time. While this state is maintained, communication progress between the PCD and the PICC is halted and the RF field can be used to harvest power to drive other processes that are not typically associated with smart card communication, such as fingerprint enrolment or verification.

Thus, with some carefully designed messaging between the card and the reader enough power can be extracted from the reader to enable authentication cycle. This method harvesting of power overcomes one of the major problem of powering a passive fingerprint authentication engine 120 in a passive RFID device 102, particularly for when a fingerprint is to be enrolled.

Furthermore, this power harvesting method allows a larger fingerprint scanner 130 to be used, and particularly an area fingerprint scanner 130, which outputs data that is computationally less intensive to process.

As discussed above, prior to use of the RFID device 102, the user of the device 102 must first enrol themself on the “virgin” device 102. After enrolment, the RFID device 102 will then be responsive to only this user. Accordingly, it is important that only the intended user is able to enrol their fingerprint on the RFID device 102.

A typical security measure for a person receiving a new credit or chip card via the mail is to send the card through one mailing and a PIN associated with the card by another. However for a biometrically-authenticated RFID device 102, such as that described above, this process is more complicated. An exemplary method of ensuring only the intended recipient of the RFID device 102 is able to enrol their fingerprint is described below.

As above, the RFID device 102 and a unique PIN associated with the RFID device 102 are sent separately to the user. However, the user cannot use the biometric authentication functionality of the RFID card 102 until he has enrolled his fingerprint onto the RFID device 102.

The user is instructed to go to a point of sale terminal which is equipped to be able to read cards contactlessly and to present his RFID device 102 to the terminal. At the same time, he enters his PIN into the terminal through its keypad.

The terminal will send the entered PIN to the RFID device 102. As the user's fingerprint has not yet been enrolled to the RFID device 102, the RFID device 102 will compare the keypad entry to the PIN of the RFID device 102. If the two are the same, then the card becomes enrolable.

The card user may then enrol his fingerprint using the method described above. Alternatively, if the user has a suitable power source available at home, he may take the RFID device 102 home and go through a biometric enrolment procedure at a later time.

The RFID device 102, once enrolled may then be used contactlessly using a fingerprint, with no PIN, or with only the PIN depending on the amount of the transaction taking place.

FIG. 4 shows the basic architecture of an alternative in which the smartcard 102 is replaced by a wireless control token 102 and the card reader 104 is replaced by an external system or device 104. In terms of the operation of the added checksum calculation the control token 102 and smartcard 102 operate in the same way, and similarly the interaction between the control token 102 and the external system 104 broadly similar to the interaction between the smartcard 102 and the card reader 104. The control token 102 may for example be a vehicle key fob and the external system 104 may hence be a vehicle. Vehicle keyless entry fobs emit a radio frequency with a designated, distinct digital identity code. When the vehicle receives the code, either transmitted when a button is pressed on the key, or transmitted in response to proximity to the vehicle, then the vehicle will respond by opening the door locks and also optionally by enabling other functions. Some vehicles have so-called master keys or smart keys which are like conventional remote keyless entry keys but with extra features reliant on proximity to the vehicle. If the master key is present close to the vehicle several functions of the vehicle are enabled just by the presence of the master key. The door locks are free, the trunk/boot is free and the engine can be started just by pressing a button somewhere on the dash board or on the centre console. The control token 102 can for example be either type of key.

The way these keys work is typically through an RF transmitter in the key that sends out a uniquely coded message periodically (or in response to a button press) and which is received by an RF unit in the vehicle. The duty cycle of this message is very small so that the battery in the key may last a long time for it is always running. When the vehicle sees the key the functions described above will be active.

The external system 104 includes a transceiver 106 for receiving a transmission from the control token 102. It is necessary that the external device include a radio frequency receiver, and optional that it also have a transmitting capability as provided by the transceiver 106. The external system 104 also includes access controlled elements 118 in communication with the transceiver 106. When the transceiver 106 receives an appropriate signal then it will permit access to the access controlled elements 118 and/or actuate certain features of the access controlled elements 118. In the example where the external system 104 is a vehicle then the access controlled elements 118 may include door locks, the vehicle ignition system, and so on. The control token 102 may permit the user to actuate and/or access features of a vehicle, acting as the external system 104, in accordance with known usage of keyless systems for vehicles.

The wireless control token 102 includes a transceiver 108 for transmitting a radio frequency signal to the transceiver of the external system 104. It is necessary that the wireless control token 102 include a radio frequency transmitter, and optional that it also have a receiving capability as is provided by the transceiver 108. The wireless control token 102 further includes a control module 113 and a biometric authorisation module in the form of a fingerprint authentication engine 120. A power source (not shown) such as a battery is used to power the transceiver 108 the control module 113 and the fingerprint authentication engine 120.

The fingerprint authentication engine 120 includes a processing unit 128 and a fingerprint sensor 130, which may be an area fingerprint sensor 130. The processing unit 128 comprises a microprocessor that is chosen to be of very low power and very high speed, so as to be able to perform biometric matching in a reasonable time and to maximise the lifespan of the power source. The processing unit 128 could be a part of the control module 113, i.e. implemented on common hardware and/or using common software elements, although typically it is separate and it is a dedicated processor connected to the fingerprint sensor 130. A checksum calculation module 129 is provided in the processing unit 128 in order to check the signal from the fingerprint sensor 130 as described above.

The fingerprint authentication engine 120 is arranged to scan a finger or thumb presented to the fingerprint sensor 130 and to compare the scanned fingerprint of the finger or thumb to stored reference fingerprint data using the processing unit 128. The stored reference fingerprint data could be stored in encrypted form in a non-volatile memory within the processing unit 128 or the control module 113. The checksum module 129 checks that the sensor output is not identical or very similar to the stored earlier readings in order to identify fraudulent attempts to access the features of the control token 102 using data gathered in a “sniffer” attack. A determination is then made as to whether the scanned fingerprint matches the reference fingerprint data using a fingerprint template and matching of minutiae, for example. Ideally, the time required for capturing a fingerprint image, performing the checksum calculation, and accurately recognising an enrolled finger is less than one second.

If a match is determined then the fingerprint authentication engine 120 communicates this to the control module 113. The control module 113 may then permit/activate the transmission of a radio frequency signal from the transceiver 108. The radio frequency signal may be continuously transmitted for a certain period of time as soon as an authorised fingerprint has been identified by the fingerprint authentication engine 120. Alternatively, the control module 113 may wait for a further action from the user, such as a button press or other input to the control token 102, which may indicate which one of several possible actions are required. For example, in the case of a vehicle the control token 102 may be able to unlock the doors of the vehicle, start the vehicle's engine or alternatively open the trunk/boot of the vehicle, with the action taken depending on a further input to the control token 102 by the user.

By the use of a transceiver for both of the wireless control token 102 and the external system 104 it becomes possible for the external system 104 to interact with the wireless control token 102 and, for example, to return a status of the external system 104. This interaction may be used in various ways, for example to influence a time period for which the wireless control token 102 should remain active after an authorised user has been identified.

Prior to use a new user of the control token 102 must first enrol their fingerprint date onto a “virgin” device, i.e. not including any pre-stored biometric data. In one example the control token 102 may be supplied in an enrolment mode and first user of the control token 102 can automatically enrol their fingerprint. In another example an enrolment mode must be initiated by an authorised external system, such as a computer system operated by the manufacturer. In the enrolment mode the fingerprint authentication engine 120 is used to gather finger print data to form a fingerprint template to be stored on the control token 102. This may be done by presenting the finger to the fingerprint sensor 130 one or more times, preferably at least three times and usually five to seven times. An exemplary method of enrolment for a fingerprint using a low-power swipe-type sensor is disclosed in WO 2014/068090 A1, which those skilled in the art will be able to adapt to the area fingerprint sensor 130 described herein.

The control token 102 may have a body 134, 140 that includes indicators for communication with the user of the control token 102, such LEDs or an LCD display. During enrolment, the user may be guided by the indicators, which tell the user if the fingerprint has been enrolled correctly. After several presentations of the finger, the fingerprint will have been enrolled and the device 102 will then respond to the fingerprint of the authorised user. The indicators may also be used during subsequent authentication in order to indicate to the user when their fingerprint is recognised and when access to the access controlled features 118 of the external system 104 has been permitted.

As described above, the control token 102 includes a fingerprint authentication engine 120 having an on-board fingerprint sensor 130 as well as the capability of enrolling the user, and thus both the matching and enrolment scans may be performed using the same fingerprint sensor 130. This improves security and reduces scanning errors as explained above.

The control token 102 may store fingerprint data for multiple users, each of which are advantageously enrolled by means of the fingerprint authentication engine 120 of the control token 102 as explained above. In the case of multiple users the control module 113 may be arranged to store the first enrolled user as an administrator level user with the ability to initiate an enrolment mode of the device during subsequent use, for example through certain inputs to the device including presentation of their fingerprint authentication as the administrator level user.

It will be appreciated that the control token 102 has particular utility when used as a keyless entry device for a vehicle, but that it could also be used in other situations. It will further be appreciated that although fingerprint authentication is a preferred method of biometric authentication of the user, alternative techniques could be used and implemented along similar lines as set out above by substituting the fingerprint sensor and fingerprint authentication engine with an alternative biometric sensing system such as facial recognition or retinal scan.

I claim:

1. A biometric authorised device comprising a biometric sensor, a processing unit for receiving an output signal from the biometric sensor, and one or more protected feature(s);
wherein access to the protected feature(s) of the device is enabled in response to identification of an authorised user via biometric data supplied through the biometric sensor to the processing unit;
wherein the device is arranged to compare the output signal of the biometric sensor with stored data based on earlier output signals for authorised users; and
wherein if the output signal is found to be identical to one of the earlier output signals then access to the protected feature(s) is not permitted.

2. A biometric authorised device as claimed in claim 1, wherein the device includes a signal checking module for providing a signal checking parameter derived from the output signal sent from the biometric sensor to the processing unit, the signal checking parameter being determined as a function of the output signal with the same function being used each time the processing unit receives an output signal from the biometric sensor and a number of past signal checking parameters being stored on the device; and wherein the device is arranged such that in the event of a new output signal being presented to the processing unit a new signal checking parameter is determined, the new signal checking parameter is compared to the stored signal checking parameters, and if the new signal checking parameter is identical to one of the stored signal checking parameters then access to the protected features of the secure element is not permitted.

3. A biometric authorised device as claimed in claim 2, wherein the signal checking module is a checksum calculation module, with the signal checking parameter hence being a checksum.

4. A biometric authorised device as claimed in claim 1, including a secure element that provides one or more of the protected feature(s).

5. A biometric authorised device as claimed in claim 4, wherein the secure element is for financial transactions and one of the protected features is access to the secure element for the purpose of carrying out a financial transaction.

6. A biometric authorised device as claimed in claim 1, wherein the biometric sensor is a fingerprint sensor.

7. A biometric authorised device as claimed in claim 1, wherein the device is arranged to enroll an authorised user by obtaining biometric data via the biometric sensor.

8. A biometric authorised device as claimed in claim 1, wherein the device is a portable device.

9. A biometric authorised device as claimed in claim 1, wherein the device is a single-purpose device for interacting with a single type of external system.

10. A method for protecting a biometric authorised device having a biometric sensor, a processing unit for receiving an output signal from the biometric sensor and a secure element with one or more protected feature(s), wherein access to the protected feature(s) of the secure element of the device is enabled in response to identification of an authorised user via biometric data supplied through the biometric sensor to the processing unit, the method comprising: storing data based on output signals received from users identified as authorised users; when a new output signal is received, comparing the new output signal of the biometric sensor with the stored data; and not enabling access to the protected feature(s) of the secure element if the output signal is found to be identical to one of the earlier output signals.

11. A computer programme product for a biometric authorised device comprising a biometric sensor and a processing unit that receives an output signal from the biometric sensor, wherein access to the protected feature(s) of the secure element of the device is enabled in response to identification of an authorised user via biometric data supplied through the biometric sensor to the processing unit, the computer programme product comprising instructions that when executed on the processing unit will configure the processing unit to: store data based on output signals received from users identified as authorised users; when a new output signal is received, to compare the new output signal of the biometric sensor with the stored data; and to not enable access to the protected feature(s) of the secure element if the output signal is found to be identical to one of the earlier output signals.
